(19) United States
(12) Patent Application Publication
(10) Pub. No.: US 2026/0260137 A1
(43) Pub. Date: Sep. 3, 2026

(54) METHOD, APPARATUS, DEVICE, AND STORAGE MEDIUM FOR TASK RESULT PREDICTION

(71) Applicant: Beijing Zitiao Network Technology Co., Ltd., Beijing (CN)

(72) Inventors: Yongchun ZHU, Beijing (CN); Guanyu JIANG, Beijing (CN); Jingwu CHEN, Beijing (CN); Feng ZHANG, Beijing (CN); Xiao YANG, Beijing (CN); Zuotao LIU, Beijing (CN)

(21) Appl. No.: 19/533,897

(22) Filed: Feb. 9, 2026

(30) Foreign Application Priority Data
Feb. 28, 2025 (CN) 202510238132.6

(51) Int. Cl. G06N 5/04

(52) U.S. Cl. CPC G06N 5/04

(57) ABSTRACT

A method includes: obtaining an input to a recommendation task, the input including at least one feature corresponding to a plurality of feature items of a plurality of objects associated with the recommendation task; encoding the input to obtain a first feature representation, the first feature representation representing the at least one feature corresponding to the plurality of feature items; decoding the first feature representation to obtain a second feature representation, the second feature representation representing a plurality of features corresponding to the plurality of feature items; and determining a first prediction result of the recommendation task based on at least the second feature representation, the first prediction result indicating whether a first object of the plurality of objects is to be recommended to at least one second object of the plurality of objects.

### CROSS-REFERENCE

The present application claims priority to Chinese Patent Application No. 202510238132.6, filed on Feb. 28, 2025, and entitled “METHOD, APPARATUS, DEVICE, AND STORAGE MEDIUM FOR TASK RESULT PREDICTION”, the entirety of which is incorporated herein by reference.

### FIELD

Example embodiments of the present disclosure generally relate to the field of computers, and in particular, to a method, an apparatus, a device, a computer-readable storage medium, and a computer program product for task result prediction.

### BACKGROUND

With the development of machine learning technologies, machine learning technologies have been widely used in various industries. Accordingly, more and more applications provide services to users based on prediction results of machine learning models, to improve service quality. For example, in a recommendation system, recommendation content may be provided to a user based on a prediction result of a machine learning model, to improve accuracy of the recommendation content. For another example, in a search engine, search content may be provided to a user based on a prediction result of a machine learning model, to improve accuracy of the search content.

### SUMMARY

In a first aspect of the present disclosure, a method for task result prediction is provided. The method includes: obtaining an input to a recommendation task, the input including at least one feature corresponding to a plurality of feature items of a plurality of objects associated with the recommendation task; encoding the input by using a trained encoder model to obtain a first feature representation, the first feature representation representing the at least one feature corresponding to the plurality of feature items; decoding the first feature representation by using a trained decoder model to obtain a second feature representation, the second feature representation representing a plurality of features corresponding to the plurality of feature items; and determining, by using a trained prediction model, a first prediction result of the recommendation task based on at least the second feature representation, the first prediction result indicating whether a first object of the plurality of objects is to be recommended to at least one second object of the plurality of objects.

In a second aspect of the present disclosure, an apparatus for task result prediction is provided. The apparatus includes: an obtaining module configured to obtain an input to a recommendation task, the input including at least one feature corresponding to a plurality of feature items of a plurality of objects associated with the recommendation task; an encoding module configured to encode the input by using a trained encoder model to obtain a first feature representation, the first feature representation representing the at least one feature corresponding to the plurality of feature items; a decoding module configured to decode the first feature representation by using a trained decoder model to obtain a second feature representation, the second feature representation representing a plurality of features corresponding to the plurality of feature items; and a determination module configured to determine, by using a trained prediction model, a first prediction result of the recommendation task based on at least the second feature representation, the first prediction result indicating whether a first object of the plurality of objects is to be recommended to at least one second object of the plurality of objects.

In a third aspect of the present disclosure, an electronic device is provided. The device includes at least one processor; and at least one memory coupled to the at least one processor and storing instructions executable by the at least one processor, the instructions, when executed by the at least one processor, causing the device to perform the method of the first aspect.

In a fourth aspect of the present disclosure, a computer-readable storage medium is provided. The computer-readable storage medium stores computer-executable instructions executable by a processor to implement the method of the first aspect.

In a fifth aspect of the present disclosure, a computer program product is provided, including computer-executable instructions, where the computer-executable instructions, when executed by a processor, implement the method of the first aspect.

It should be appreciated that content described in this Summary section is neither intended to identify key or essential features of embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages, and aspects of embodiments of the present disclosure become more apparent with reference to the following detailed description and in conjunction with the drawings. In the drawings, the same or similar reference numerals denote the same or similar elements.

FIG. 1 is a schematic diagram of an example environment in which embodiments of the present disclosure may be implemented;

FIG. 2 is a flowchart of a process for task result prediction according to some embodiments of the present disclosure;

FIG. 3 is a schematic diagram of an example architecture for task result prediction according to some embodiments of the present disclosure;

FIG. 4 is a schematic diagram of an example architecture for task result prediction according to some embodiments of the present disclosure;

FIG. 5 is a schematic structural block diagram of an example apparatus for task result prediction according to some other embodiments of the present disclosure; and

FIG. 6 is a block diagram of an electronic device capable of implementing a plurality of embodiments of the present disclosure.

### DETAILED DESCRIPTION OF EMBODIMENTS

Embodiments of the present disclosure are described in more detail below with reference to the drawings. Although some embodiments of the present disclosure are shown in the drawings, it should be understood that the present disclosure may be implemented in various forms, and should not be construed as being limited to the embodiments set forth herein. Rather, these embodiments are provided for more thorough and complete understanding of the present disclosure. It should be understood that the drawings and embodiments of the present disclosure are only used for illustrative purposes, and are not used to limit the protection scope of the present disclosure.

In the description of the embodiments of the present disclosure, the term “include/comprise” and similar terms should be construed as open-ended inclusions, that is, “include/comprise but not limited to”. The term “based on” should be construed as “at least partially based on”. The term “one embodiment” or “the embodiment” should be construed as “at least one embodiment”. The term “some embodiments” should be construed as “at least some embodiments”. The following may also include other explicit and implicit definitions.

In this specification, unless explicitly stated, “performing a step in response to A” does not mean that the step is performed immediately after “A”, but may include one or more intermediate steps.

It may be understood that the data involved in the technical solution (including but not limited to the data itself, acquisition or use of the data) should comply with requirements of corresponding laws, regulations, and related provisions.

It may be understood that before the use of the technical solutions disclosed in the embodiments of the present disclosure, the user shall be informed of the type, range of use, use scenarios, etc., of personal information involved in the present disclosure in an appropriate manner in accordance with relevant laws and regulations, and the authorization of the user shall be obtained.

For example, in response to receiving an active request from a user, prompt information is sent to the user to clearly inform the user that the requested operation will require access to and use of the user's personal information, so that the user may independently choose, based on the prompt information, whether to provide the personal information to software or hardware, such as an electronic device, an application, a server, or a storage medium, that performs the operations of the technical solution of the present disclosure.

As an optional but non-restrictive implementation, in response to receiving the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It may be understood that the above process of notifying and obtaining user authorization is only illustrative, and does not constitute a limitation on the implementations of the present disclosure. Other manners that satisfy the relevant laws and regulations may also be applied in the implementations of the present disclosure.

As used herein, the term “model” may learn a correlation between respective inputs and outputs from training data, so that a corresponding output may be generated for a given input after the learning is completed. The generation of the model may be based on machine learning technologies. Deep learning is a machine learning algorithm that uses multiple layers of processing units to process inputs and provide corresponding outputs. A neural network model is an example of a model based on deep learning. Herein, a “model” may also be referred to as a “machine learning model”, a “learning model”, a “machine learning network”, or a “learning network”, which may be used interchangeably herein.

A “neural network” is a machine learning network based on deep learning. A neural network may process an input and provide a corresponding output, and usually includes an input layer and an output layer, as well as one or more hidden layers between the input layer and the output layer. Neural networks used in deep learning applications usually include many hidden layers, thereby increasing the depth of the network. The layers of the neural network are connected in sequence, so that an output of a previous layer is provided as an input of a next layer, where the input layer receives the input to the neural network, and an output of the output layer serves as a final output of the neural network. Each layer of the neural network includes one or more nodes (also referred to as processing nodes or neurons), and each node processes an input from the previous layer.

Generally speaking, machine learning may roughly include three stages, namely, a training stage, a test stage, and an application stage (also referred to as an inference stage). In the training stage, a given model may be trained using a large amount of training data, and a parameter value may be updated through continuous iteration, until the model may obtain consistent inference that satisfies an expected objective from the training data. Through training, the model may be considered as being capable of learning a correlation (also referred to as a mapping from the input to the output) from an input to an output from the training data. The parameter value of the trained model is determined. In the test stage, a test input is applied to the trained model to test whether the model may provide a correct output, thereby determining performance of the model. In the application stage, the model may be used to process an actual input based on the parameter value obtained through training, to determine a corresponding output.

As mentioned above, with the development of machine learning technologies, machine learning technologies have been widely used in various industries. Accordingly, more and more applications provide services to users based on prediction results of machine learning models, to improve service quality. For example, in a recommendation system, recommendation content may be provided to a user based on a prediction result of a machine learning model, to improve accuracy of the recommendation content. For another example, in a search engine, search content may be provided to a user based on a prediction result of a machine learning model, to improve accuracy of the search content. However, in actual applications, a model input of a machine learning model is prone to missing a feature. For example, in a recommendation system, one or more features associated with recommendation content are likely to be missing. This may affect the accuracy of the prediction result of the machine learning model.

In view of this, embodiments of the present disclosure provide an improved solution for task result prediction. In this solution, an input to a recommendation task is obtained, where the input includes at least one feature corresponding to a plurality of feature items of a plurality of objects associated with the recommendation task. The input is encoded by using a trained encoder model to obtain a first feature representation representing the at least one feature corresponding to the plurality of feature items. The first feature representation is decoded by using a trained decoder model to obtain a second feature representation representing a plurality of features corresponding to the plurality of feature items. A first prediction result of the recommendation task is determined by using a trained prediction model based on at least the second feature representation. The first prediction result may indicate whether a first object of the plurality of objects is to be recommended to at least one second object of the plurality of objects.

In the embodiments of the present disclosure, if a portion of features is missing in the input, the first feature representation is decoded by using the decoder to obtain the second feature representation, which may play a role in supplementing the missing feature to some extent, and may improve a representation capability for the input. The prediction result of the recommendation task is determined by using the prediction model based on the supplemented second feature representation, so that the accuracy of the prediction result of the recommendation task may be improved.

Various example implementations of this solution are described in detail below with further reference to the drawings.

### Example Environment

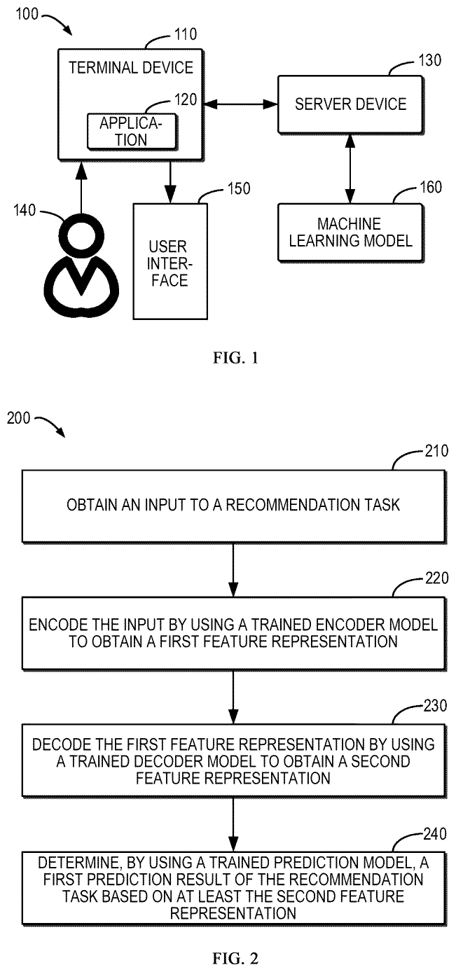

FIG. 1 is a schematic diagram of an example environment 100 in which the embodiments of the present disclosure may be implemented. In this example environment 100, an application 120 is installed on a terminal device 110. A user 140 may interact with the application 120 via the terminal device 110 and/or an attached device of the terminal device 110.

In some embodiments of the present disclosure, the application 120 may be any appropriate application that may provide a service to the user 140 based on a prediction result of a machine learning model 160. In some embodiments, the application 120 may present content to the user 140 based on the prediction result of the machine learning model 160. The content may include but is not limited to a web page, a document, an image, audio, video, or content in another modality.

In some embodiments, if the application 120 is active, the terminal device 110 may present a user interface 150 of the application 120. The user interface 150 may include various types of content that may be provided by the application 120, such as a conversation page between a user and a digital assistant (in which a current conversation and a historical conversation, including text conversation content, may be presented), a presentation interface of text content, a playing interface of voice, a playing interface of video, and so on.

In some embodiments, the application 120 may use one or more machine learning models 160 (for example, the one or more machine learning models may include a machine learning model 160-1, a machine learning model 160-2, . . . , a machine learning model 160-M, and so on, where M is a positive integer. For ease of description, the one or more machine learning models are collectively referred to as machine learning model(s) 160 herein) to support interaction with the user 140. For example, the application 120 may use the one or more machine learning models 160 to determine content matching the user 140.

In some embodiments, the terminal device 110 communicates with a server device 130 to implement provision of the service of the application 120. As shown in FIG. 1, the server device 130 may invoke the machine learning model 160 to support interaction between the application 120 and the user 140 based on the prediction result of the machine learning model 160. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a gaming device, or any combination thereof, including fittings and peripherals of these devices or any combination thereof. In some embodiments, the terminal device 110 may also support any type of user-specific interface (such as “wearable” circuitry, etc.). The server device 130 may be various types of computing systems/servers that may provide computing power, including but not limited to mainframes, edge computing nodes, computing devices in cloud environments, and so on. For example, the server device 130 may be implemented based on a cloud environment.

The machine learning models 160 may be different types of models. In some embodiments, the one or more machine learning models 160 may be implemented as an encoder model, a decoder model, or a prediction model. In some embodiments, the one or more machine learning models 150 may be constructed based on a diffusion model. The diffusion model, also known as a diffusion probabilistic model, is a class of generative models. The model generates data by simulating a diffusion process. This process is inspired by physical processes such as thermal diffusion. The diffusion model includes a forward diffusion process and a reverse diffusion process. The diffusion model simulates a forward diffusion process of gradually adding noise, and then learns how to reverse the process to generate new data samples.

In the forward diffusion process, noise is gradually added to data, making the data more and more random through a series of steps until the data resembles pure noise. This process may be seen as a Markov chain, in which Gaussian noise is added to the data at each step. The forward diffusion process may be expressed as: q(xₜ|xₜ₋₁)= [symbol] (xₜ;\sqrt{αₜ}xₜ₋₁,(1−αₜ)I), where xₜ is noisy data at the tth step, and αₜ is used to control an amount of added noise. The forward diffusion process is performed in model training, and the data for adding noise is a training sample.

In the reverse diffusion process (or referred to as reverse denoising process), the model learns how to reverse the step of adding noise. Starting from pure noise, the diffusion model gradually removes noise to generate data that matches the training distribution. The reverse diffusion process is usually simulated by using a neural network, which predicts the noise added at each step: p_{θ}(xₜ₋₁|xₜ)= [symbol] (xₜ₋₁;u_{θ}(xₜ,t),σ_{θ}(xₜ,t)), where u_{θ} and σ_{θ} are model parameters obtained through learning. After completing the model training, the model that performs the reverse diffusion process may first sample from a noise distribution, and perform iterative denoising by using the model, until the desired data is obtained.

In the diffusion model, time steps refer to a number of steps of adding noise in the forward diffusion process. The total number of steps T is usually a preset value, which represents how many steps are required for the transformation process from the original data to the pure noise. At each time step t, Gaussian noise is added to the data according to a predetermined noise scheme. This process is continuous, and each step depends on a result of a previous step.

During data generation, inference steps of the diffusion model refer to a number of steps required to restore from the pure noise to the original data in the reverse diffusion process. The number of inference steps directly affects quality and speed of the generated data. Generally speaking, the greater the number of inference steps, the higher the quality of the generated data, but this will also increase the computing cost and time. In practical applications, the number of inference steps may be adjusted to balance the generation quality and efficiency. In some embodiments, the inference steps correspond to the time steps, and each inference step may correspond to one or more time steps. For example, if the total number of time steps of the diffusion model is 1000, and the number of inference steps is set to 50, then each inference step may correspond to 20 time steps.

It should be understood that the structures and functions of the elements in the environment 100 are described for illustrative purposes only, without suggesting any limitation on the scope of the present disclosure.

Some example embodiments of the present disclosure are described below with continued reference to the drawings.

### Example Process

Some example embodiments of the present disclosure are described below with continued reference to the drawings. FIG. 2 is a flowchart of a process 200 for task result prediction according to some embodiments of the present disclosure. Some or all of the process 200 may be implemented by the server device 130, or may be implemented by the server device 130 in cooperation with the terminal device 110. In the following, for ease of discussion, the execution of the process 200 is described from the perspective of the server device 130, but this is only an example.

At block 210, the server device 130 obtains an input to a recommendation task. In some embodiments, the recommendation task may include a plurality of associated objects, and the plurality of objects may include at least one first object and at least one second object. A prediction result of the recommendation task is to determine whether a first object of the plurality of objects is to be recommended to at least one second object of the plurality of objects. The input may include at least one feature corresponding to a plurality of feature items of the plurality of objects. As an example, the input may be expressed as x={x₁, x₂, . . . , x_{N}}, where xᵢ represents a feature corresponding to an ith feature item,

$$i ∈ [ 1 , N ] ,$$

and N represents a number of feature items. In practical applications, corresponding feature(s) for portion of feature items may be missing in the input, and the feature item for which the corresponding feature is missing may be set to 0 or a null set. For example, x₁ or x₂ may be set to 0.

In some embodiments, the recommendation task may indicate determining an association degree between the at least one first object and the at least one second object. The input may include at least one first feature corresponding to a plurality of first feature items of the at least one first object and at least one second feature corresponding to a plurality of second feature items of the at least one second object. Here, the feature of the first object and the feature of the second object may be the same or different.

As an example, the at least one first object may include at least one piece of recommendation content, and the at least one second object may include at least one recommendation audience. The task may indicate determining an association degree between the at least one piece of recommendation content and the at least one recommendation audience. The application 120 may be configured to present recommendation content to the user 140 based on the association degree between the at least one piece of recommendation content and the at least one recommendation audience. The input may include feature(s) corresponding to a plurality of feature items of the recommendation content and feature(s) corresponding to a plurality of feature items of the recommendation audience. In practical applications, for some feature items related to the recommendation content or some feature items related to the recommendation audience that are required for the input, the corresponding features may not be collected. If the association degree between the recommendation content and the recommendation audience is predicted directly based on the input with missing feature(s), the accuracy of the prediction result will be low.

It should be noted that the process 200 of task result prediction may be used for other appropriate tasks, and is not limited to recommendation tasks. In some embodiments, the process 200 may also be used for a feature attribute determination task. The task may indicate analyzing a feature attribute of at least one object associated with the task. As an example, the at least one object may include at least one piece of content, the task may indicate determining a quality score of the at least one piece of content, and the input may include a theme, a type, a subject matter, a style, etc., of the content. As another example, the object may include a physical object or an entity object, such as a product. The task may indicate determining a recommendation coefficient of at least one product, and the recommendation coefficient may indicate a recommendable degree of the corresponding product. The input may include basic features (such as a name, a code, and a manufacturer) of the at least one product, physical features (such as a material, a color, and a size), and functional features (such as a main function and an auxiliary function). In practical applications, for some feature items of the product required for the input, the corresponding features may not be collected. If the recommendation coefficient of the product is predicted directly based on the input with missing feature(s), the predicted recommendation coefficient may have low accuracy.

In some embodiments, the process 200 may also be used for a classification task. The task may indicate determining a classification label of at least one classification object of the classification task. The input may include at least one feature of a plurality of feature items of the at least one classification object. As an example, the at least one classification object may include content provided by the application 120, such as music content, text content, video content, or live stream content. The task may indicate determining a classification label of the content, such as positive, negative, neutral, romance, comedy, science fiction, and so on. The input corresponding to the classification task may include metadata (such as a poster and a posting time) of the content, structural features (such as a title and a length), text features, semantic features, image features, audio features, and so on.

It should be understood that the above tasks and the inputs corresponding to the tasks are examples. In practical applications, any other appropriate tasks may also be included, and accordingly, the input may include various appropriate features required for determining the prediction result of the corresponding task. The type of the task and the specific content of the features in the input are not limited in the embodiments of the present disclosure.

At block 220, the server device 130 encodes the input by using a trained encoder model to obtain a first feature representation. The first feature representation represents the at least one feature corresponding to the plurality of feature items. The encoder model may be trained to encode the features in the input, to obtain a feature representation that encodes the input into a specific feature space. In some embodiments, the server device 130 may encode the input by using the trained encoder model, to obtain the first feature representation encoded into a latent feature space of the encoder model. In some embodiments, the encoder model may be constructed based on a deep network including an embedding layer. Certainly, the encoder model may be constructed by using any other appropriate model structure, and the model structure of the encoder model is not limited in the embodiments of the present disclosure.

In some embodiments, the input may include at least one first feature corresponding to a plurality of first feature items of the first object and at least one second feature corresponding to a plurality of second feature items of the second object. The server device 130 may use the encoder model to encode the at least one first feature and the at least one second feature, to obtain the first feature representation encoded into the latent feature space.

At block 230, the server device 130 decodes the first feature representation by using a trained decoder model to obtain a second feature representation, the second feature representation representing a plurality of features corresponding to the plurality of feature items. The decoder model may be trained to perform decoding through the first feature representation, to supplement a feature representation corresponding to a missing feature in the input, thereby obtaining the supplemented second feature representation. In this case, the process of decoding the first feature representation by using the trained decoder model to obtain the second feature representation may be understood as a process of “feature padding”, which may supplement the feature representation corresponding to the missing feature in the input to some extent. For example, a feature representation corresponding to the portion of features associated with the recommendation content is supplemented, or a feature representation corresponding to the portion of features associated with the recommendation audience is supplemented.

In some embodiments, the decoder model may be trained to decode the first feature representation in a specific feature space to obtain the second feature representation in the specific feature space, so as to avoid changing the feature space of the feature representation while padding features. As an example, the decoder model may be trained to decode the first feature representation in the latent feature space to obtain the second feature representation in the latent feature space. In some embodiments, the encoder model and the decoder model are jointly trained.

In some embodiments, the decoder model performs decoding based on a reverse diffusion process corresponding to a diffusion model. In this case, the decoder model may also be referred to as a diffusion-based decoder. If corresponding feature(s) for a portion of feature items is missing in the input, the first feature representation generated based on the input may be regarded as a feature representation containing noise. Decoding the first feature representation by using the reverse diffusion process of the diffusion model may be regarded as removing noise from the feature representation containing the noise, to obtain the second feature representation from which the noise is removed. The second feature representation from which the noise is removed supplements the feature representation corresponding to the missing feature to some extent. Compared with the first feature representation that may represent the at least one feature included in the input, the second feature representation may not only represent the at least one feature included in the input, but also represent the determined feature(s) to some extent. In this way, the capability of the diffusion model to remove noise from the feature representation is utilized, to achieve the purpose of padding the input with the missing feature, and a relatively complete feature representation may be obtained. It should be understood that the use of the diffusion model to implement the decoder model is only an example. In practical applications, another model structure with denoising capability may be selected to implement the decoder model according to actual needs. The model structure of the decoder model is not specifically limited in the embodiments of the present disclosure.

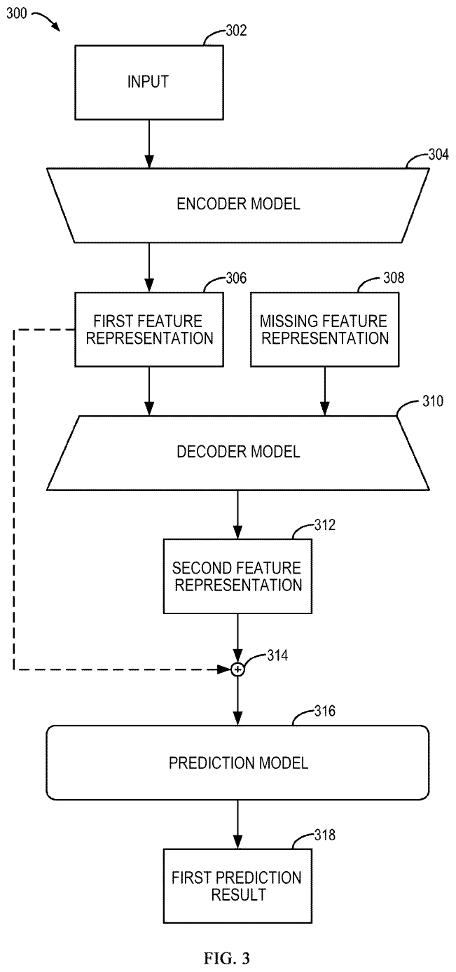

In some embodiments, FIG. 3 is a schematic diagram of an example architecture 300 for task result prediction according to some embodiments of the present disclosure. As shown in FIG. 3, the server device 130 may encode an input 302 by using an encoder model 304 to obtain a first feature representation 306. The server device 130 may further determine a missing feature representation 308 corresponding to the input 302. The server device 130 may decode the first feature representation 306 by using a decoder model 310 based on the missing feature representation 308, to obtain a second feature representation 312. The missing feature representation here may indicate a feature item, in the plurality of feature items, for which a corresponding feature is missing. The feature item whose corresponding feature is missing is indicated by the missing feature representation, so that the decoder model may specifically pad the missing feature, and the accuracy of the second feature representation may be improved.

As an example, the input 302 may be expressed as x={x₁, x₂, . . . , x_{N}}, where xᵢ represents a feature. The missing feature representation 308 may be expressed as s={s₁, s₂, . . . , s_{N}}, and sᵢ may indicate whether a corresponding feature for a feature item corresponding to xᵢ is missing. If the corresponding feature for the feature item corresponding to sᵢ is missing, sᵢ may be set to 1. If the corresponding feature for the feature item corresponding to xᵢ is not missing, sᵢ may be set to 0. The encoder model 304 may be expressed as h(⋅), and the first feature representation 306 may be expressed as z=h(x). A denoising function of the decoder model 310 may be expressed as g(⋅). In this case, the second feature representation 312 may be expressed as z′=g([s,h(x)]). It should be understood that the specific data structure of the missing feature representation described above is only an example. In practical applications, the missing feature representation may indicate the feature item for which the corresponding feature is missing in any appropriate manner, and the specific data structure of the missing feature representation is not limited in the embodiments of the present disclosure.

At block 240, the server device 130 determines, by using a trained prediction model, a first prediction result of the recommendation task based on at least the second feature representation. The prediction model may be trained to determine the prediction result of the recommendation task based on the feature representation corresponding to the input. In some embodiments, the prediction model may be implemented based on any appropriate model network that matches the recommendation task. For example, the prediction model may be implemented based on a generative model, or the prediction model may be implemented based on a classification model. Certainly, the prediction model may also be implemented based on any other appropriate model network.

In some embodiments, the first prediction result indicates an association degree between the at least one first object and the at least one second object. The server device 130 may determine whether the association degree exceeds a threshold association degree. If the association degree between the first object and the at least one second object exceeds the threshold association degree, the server device 130 may determine that the first object is suitable to be recommended to the corresponding at least one second object. If the association degree between the first object and the at least one second object does not exceed the threshold association degree, the server device 130 may determine that the first object is not suitable to be recommended to the corresponding at least one second object.

In some examples, the first prediction result may include a correlation probability or a correlation coefficient between the at least one piece of recommendation content and the at least one recommendation audience, and the association degree between the recommendation content and the recommendation audience is indicated by the correlation probability or the correlation coefficient. The application 120 may present the recommendation content to the recommendation audience based on the first prediction result.

As an example, the first prediction result may include a plurality of correlation probabilities, and each of the correlation probabilities may indicate an association degree between corresponding recommendation content and a corresponding recommendation audience. The server device 130 may determine whether the plurality of correlation probabilities exceed a probability threshold. If the correlation probability exceeds the probability threshold, the server device 130 may push the corresponding recommendation content to the terminal device 110 associated with the corresponding recommendation audience. The terminal device 110 may present the corresponding recommendation content, such as a page, audio, video, an image, etc., through the user interface 150 of the application 120. In an actual recommendation system, a situation often occurs in which a corresponding feature cannot be collected for a feature item related to the recommendation content or a feature item related to the recommendation audience. The decoder model may be used to supplement the feature representation corresponding to at least some of the missing features, so that a relatively complete feature representation may be obtained, and the association degree between the recommendation content and the recommendation audience may be accurately predicted. On this basis, the matching recommendation content may be accurately recommended to the recommendation audience, which is beneficial to improving the quality of content recommendation.

As another example, the first prediction result may include a plurality of correlation coefficients, and each of the correlation coefficients may indicate an association degree between corresponding recommendation content and a corresponding recommendation audience. The server device 130 may sort the plurality of correlation coefficients, and select a predetermined number of correlation coefficients ranking in top order from the sorted correlation coefficients. The server device 130 may send matching recommendation content to the terminal device 110 associated with respective recommendation audience based on association relationships between recommendation content and recommendation audiences indicated by the predetermined number of correlation coefficients. The terminal device 110 may use the application 120 to present the corresponding recommendation content. Certainly, the above recommendation strategy is only an example. In practical applications, any appropriate recommendation strategy may be selected to push recommendation content to the recommendation audience according to actual needs. This is not limited in the embodiments of the present disclosure.

In some embodiments, if the process 200 is used to perform another task, the first prediction result may also include other content. In some examples, if the process 200 is used to perform the feature attribute determination task, the first prediction result may also indicate a feature attribute (such as a quality score of content, a recommendation coefficient of a product, etc.) of an object associated with the task. In some examples, if the process 200 is used to perform the classification task, the first prediction result may include classification labels of a plurality of classification objects. As an example, the first prediction result may include classification labels of a plurality of pieces of content of the application 120. The server device 130 may match respective pieces of content to different sections of the application 120 based on the classification labels, or the server device 130 may also push recommendation content to different recommendation audiences based on the classification labels. The decoder model may be used to achieve the effect of padding features to some extent, and a relatively complete feature representation may be obtained, which is beneficial to improving the accuracy of the classification labels, and then respective pieces of content of the application 120 may be accurately allocated, which is beneficial to improving the quality of content provision of the application 120.

It should be understood that the first prediction result described above is only an example. The first prediction result matches the task, and when the tasks are different, the specific content of the first prediction result may also be different. The content of the first prediction result is not specifically limited in the embodiments of the present disclosure.

In some embodiments, as shown in FIG. 3, at block 314, the server device 130 may concatenate the first feature representation 306 and the second feature representation 312 to obtain a third feature representation. Then, the server device 130 may determine a first prediction result 318 of the recommendation task by using a prediction model 316 based on the third feature representation. This helps improve the accuracy of the first prediction result.

The specific process of task result prediction in the embodiments of the present disclosure is introduced above. If a portion of features is missing in the input, the first feature representation is decoded by using the decoder to obtain the second feature representation, which may play a role in supplementing the missing feature(s) to some extent, and may improve a representation capability for the input. The prediction result of the recommendation task is determined by using the prediction model based on the supplemented second feature representation, so that the accuracy of the prediction result of the recommendation task may be improved.

The following describes the training process of the encoder model, the decoder model, and the prediction model. It should be understood that such a training process may be performed by an appropriate training system. The training system may include but is not limited to the server device 130.

In some embodiments of the present disclosure, a training system may determine a first sample input and a second sample input for a sample recommendation task. The first sample input includes a plurality of sample features corresponding to a plurality of sample feature items of a sample object associated with the sample recommendation task, and the second sample input includes a portion of sample features corresponding to the plurality of sample feature items.

In some embodiments, the training system may obtain the first sample input for the sample recommendation task. Then, the training system may remove sample feature(s) corresponding to one or more sample feature items from the first sample input to obtain the second sample input. The input of the recommendation task includes a plurality of feature items, and the input is in a discrete data space. By removing the sample feature(s) corresponding to the one or more sample feature items from the first sample input, a discrete feature missing manner in a real input may be simulated, so that the obtained second sample input is closer to the input in a real application scenario, thereby improving a training effect of the model. In other words, the process of discarding sample noise corresponding to the one or more sample feature items from the first sample input may also be regarded as performing a feature masking operation on the one or more sample feature items in the first sample input, to simulate a feature missing manner in a real discrete feature space, so that a better training effect may be achieved.

In some embodiments, the training system may determine a time step parameter corresponding to the first sample input. The number of sample feature items to be removed from the first sample input is determined based on the time step parameter. Then, the training system may remove sample features corresponding to the number of sample feature items from the first sample input, to obtain the second sample input. In some cases, the operation of removing the sample features from the first sample may also be referred to as feature dropout. Removing the sample features from the first sample input based on the time step parameter may simulate a discrete feature loss process in a real scenario.

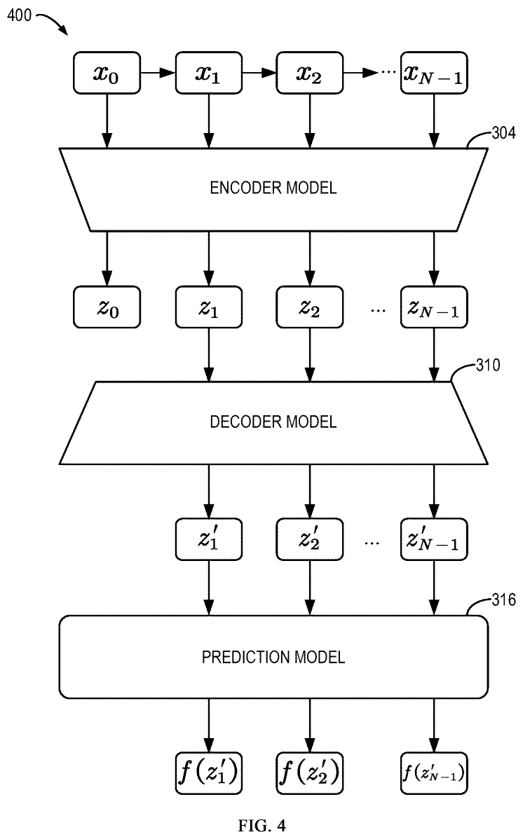

In some examples, FIG. 4 is a schematic diagram of an example architecture 400 for task result prediction according to some embodiments of the present disclosure. As shown in FIG. 4, the decoder model 310 may be a decoder model based on a diffusion model. The training system may pre-define removing sample feature(s) corresponding to one or more sample feature items at a uniform probability in each time step in a forward diffusion process of the diffusion model. It is assumed that the first sample input x₀ (which may also be referred to as an original sample) includes N sample feature items, and the training system may randomly sample a time step parameter T in a value range (0,N) of a uniform distribution. Then, the training system may determine, based on the time step parameter T, the number of sample feature items to be removed from the first sample input x₀.

For example, it is assumed that the training system pre-defines removing a sample feature corresponding to one sample feature item in each time step in the forward diffusion process of the diffusion model. If a value of the time step parameter T is 1, the training system may remove a sample feature of one sample feature item from the first sample input x₀ to obtain a second sample input xᵢ. If a value of the time step parameter T is 2, the training system may remove sample features of two sample feature items from the first sample input x₀ to obtain a second sample input x₂. If a value of the time step parameter T is N−1, the training system may remove sample features of N−1 sample feature items from the first sample input x₀ to obtain a second sample input x_{N-1}. It should be understood that in an actual training process, one or more time step parameters T may be randomly determined for each first sample input x₀. Correspondingly, one or more second sample inputs may be obtained, and the one or more second sample inputs may include any one or more of {x₁, . . . , x_{N-1}}. In some cases, the second sample input may also be expressed as x_{T}, x_{T}∈{x₁, . . . , x_{N-1}}.

In some embodiments of the present disclosure, the training system may encode the first sample input by using the encoder model to obtain a first sample feature representation, the first sample feature representation representing a plurality of sample features corresponding to the plurality of sample feature items. In some examples, as shown in FIG. 4, the training system may encode the first sample input x₀ by using the encoder model 304 to obtain a first sample feature representation z₀.

In some embodiments of the present disclosure, the training system may encode the second sample input by using the encoder model to obtain a second sample feature representation, the second sample feature representation representing a portion of sample features corresponding to the plurality of sample feature items. In some examples, as shown in FIG. 4, the training system may separately encode the second sample input x_{T} by using the encoder model 304 to obtain the second sample feature representations, for example, one or more of a second sample feature representation z₁, a second sample feature representation z₂, . . . , and a second sample feature representation z_{N-1}. In some cases, the second sample feature representation may be expressed as

$${𝓏}_{T} ∈ \{ {𝓏}_{1} , … , {𝓏}_{N - 1} \} .$$

In some embodiments of the present disclosure, the training system may decode the second sample feature representation by using the decoder model to obtain a third sample feature representation. The third sample feature representation represents a plurality of sample features corresponding to the plurality of sample feature items. In some examples, as shown in FIG. 4, the training system may use the decoder model 310 to decode the second sample feature representation z_{T} based on a reverse diffusion process of the diffusion model, to obtain the third sample feature representation, for example, a third sample feature representation

$$\\ {z}_{1}^{′} ,$$

a third sample feature representation

$$\\ {z}_{2}^{′} ,$$

. . . , and a third sample feature representation

$$\\ {z}_{N - 1}^{′} .$$

In some cases, the third sample feature representation may be expressed as

$$\\ \\ {z}_{T}^{′} ∈ \{ {z}_{1}^{′} , {z}_{2}^{′} , … , {z}_{N - 1}^{′} \} .$$

Alternatively, the third sample feature representation may also be uniformly expressed as

$$\\ {z}_{0}^{′} .$$

In some embodiments, the training system may determine a missing feature representation s of the second sample input x_{T}. The missing feature representation may indicate a sample feature item, in the plurality of sample feature items of the second sample input x_{T}, for which a corresponding feature is missing. The training system may use the decoder model to decode the corresponding second sample feature representation z_{T} based on the missing feature representation s, to obtain the third sample feature representation

$$\\ {z}_{T}^{′} .$$

If the decoder model 310 is expressed as g(⋅), the third sample feature representation may be expressed as

$$\\ {z}_{T}^{′} = g ( [ s , {z}_{T} ] ) .$$

In some embodiments, the decoder model may be implemented based on a diffusion model. The first sample feature representation, the second sample feature representation, and the third sample feature representation may be in a latent feature space of the prediction model. Specifically, the training system performs a forward diffusion process on the original sample input in a discrete data space of the original sample input. Then, the training system performs a reverse diffusion process in an asymmetric manner (which may also be referred to as asymmetric diffusion). The reverse diffusion process is performed by using the diffusion-based decoder model in the latent feature space to reconstruct the latent feature representation of the original input, which may be regarded as a process of feature padding. This helps reduce information loss, and helps retain information in the latent feature representation (i.e., the third sample feature representation), to improve information integrity in the latent feature representation. In some cases, the encoder model, the diffusion-based decoder model, and the prediction model may be applied to a recommendation system, and the encoder model, the decoder model, and the prediction model as a whole may also be referred to as an asymmetric diffusion-based recommendation model.

In some embodiments of the present disclosure, the training system adjusts a parameter of the encoder model and a parameter of the decoder model based on at least a first difference between the first sample feature representation and the third sample feature representation, to obtain the trained encoder model and the trained decoder model. In some examples, the training system may adjust the parameter of the encoder model and the parameter of the decoder model based on the first difference between the one or more third sample feature representations and the first sample feature representation. As an example, the training system may adjust the parameter of the encoder model and the parameter of the decoder model based on the first difference by using a reconstruction loss function shown below:

$$\\ \begin{matrix}{ℒ}_{recon} = ‖ {z}_{T}^{′} - {z}_{0} ‖ & ( 1 )\end{matrix}$$

In some embodiments, the training system may obtain a sample task result corresponding to the first sample input in the sample recommendation task. The training system determines a second prediction result of the sample recommendation task by using the prediction model based on at least the third sample feature representation. Then, the training system may adjust the parameter of the encoder model and the parameter of the decoder model based on the first difference and a second difference between the sample task result and the second prediction result. The sample task result may also be referred to as a ground-truth task result, and the sample task result indicates a ground truth corresponding to the corresponding first sample input.

As an example, as shown in FIG. 4, the training system may obtain a sample task result corresponding to each first sample input x₀. Each first sample input x₀ may have a corresponding label y∈{0, 1}, for example, the label of y=1 may indicate that a recommendation object and a recommendation audience are associated or matched, and the label of y=0 may indicate that the recommendation object and the recommendation audience are not associated or matched. It is assumed that the prediction model 316 is expressed as f(⋅), the training system may further provide the third sample feature representation

$$\\ {z}_{T}^{′}$$

to the prediction model 316 to obtain a second prediction result

$$\\ f ( {z}_{T}^{′} ) ,$$

for example, any one of a second prediction result

$$\\ f ( {z}_{1}^{′} ) ,$$

a second prediction result

$$\\ f ( {z}_{2}^{′} ) ,$$

. . . , and a second prediction result

$$\\ f ( {z}_{N - 1}^{′} ) .$$

The training system may adjust the parameter of the encoder model and the parameter of the decoder model by using the reconstruction loss function shown in formula (1) and a secondary task-oriented loss function shown below:

$$\\ \begin{matrix}{ℒ}_{aux} = - y log f ( {z}_{T}^{′} ) - ( 1 - y ) log ( 1 - f ( {z}_{T}^{′} ) ) & ( 2 )\end{matrix}$$

In some embodiments, the training system may determine a third prediction result of the sample recommendation task by using the prediction model based on the second sample feature representation. Then, the training system may adjust the parameter of the encoder model and the parameter of the decoder model based on the first difference and a third difference between the sample recommendation task result and the third prediction result.

As an example, as shown in FIG. 4, the training system may further provide one or more second sample feature representations z_{T} to the prediction model 316 to obtain the third prediction result. If the prediction model is expressed as f(⋅), the third prediction result may be expressed as ŷ=f(z_{T}). The training system may adjust the parameter of the encoder model and the parameter of the decoder model by using the reconstruction loss function shown in formula (1) and a cross-entropy loss function shown below:

$$\\ \begin{matrix}{ℒ}_{main} = - y log \hat{y} - ( 1 - y ) log ( 1 - \hat{y} ) & ( 3 )\end{matrix}$$

It may be understood that the training system may alternatively adjust the parameter of the encoder model and the parameter of the decoder model based on [symbol] .

In some embodiments, the prediction model may be jointly trained with the encoder model and the decoder model. That is, the training system may jointly train the encoder model, the decoder model, and the pre-trained model. As an example, the training system may alternatively adjust the parameter of the encoder model, the parameter of the decoder model, and a parameter of a pre-trained model based on [symbol] , to jointly train the encoder model, the decoder model, and the pre-trained model.

In this way, in the embodiments of the present disclosure, by performing feature dropout on the original sample input (i.e., the first sample input), the discrete feature loss process in the real scenario may be simulated, and the obtained second sample input is closer to the real sample in the discrete data space. By performing the forward diffusion process in the discrete data space and the asymmetric reverse diffusion process in the latent feature space, information loss may be reduced, which is beneficial to retaining personalized information in the latent feature representation, forming a relatively complete and robust feature representation, and enhancing the representation learning ability of the decoder model.

### Example Apparatus and Device

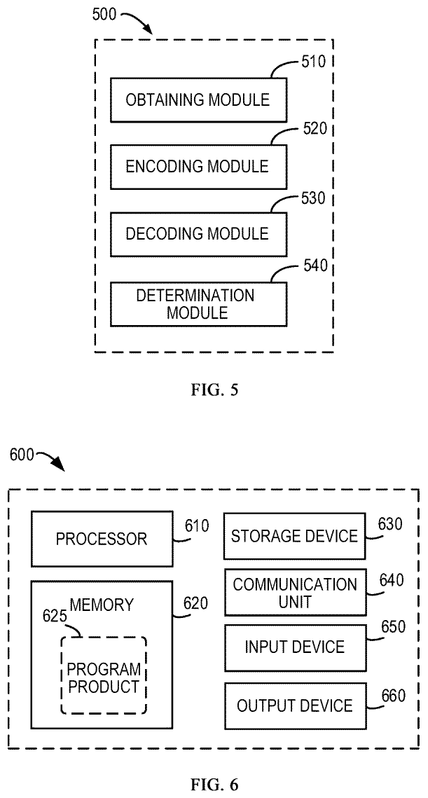

The embodiments of the present disclosure further provide corresponding apparatuses for implementing the foregoing methods or processes. FIG. 5 is a schematic structural block diagram of an example apparatus 500 for task result prediction according to some embodiments of the present disclosure. The apparatus 500 may be implemented as or included in the server device 130. Each module/component in the apparatus 500 may be implemented by hardware, software, firmware, or any combination thereof.

As shown in FIG. 5, the apparatus 500 includes: an obtaining module 510 configured to obtain an input of a recommendation task, the input including at least one feature corresponding to a plurality of feature items of a plurality of objects associated with the recommendation task; an encoding module 520 configured to encode the input by using a trained encoder model to obtain a first feature representation, the first feature representation representing at least one feature corresponding to the plurality of feature items; a decoding module 530 configured to decode the first feature representation by using a trained decoder model to obtain a second feature representation, the second feature representation representing a plurality of features corresponding to the plurality of feature items; and a determination module 540 configured to determine, by using a trained prediction model, a first prediction result of the recommendation task based on at least the second feature representation, the first prediction result indicating whether a first object in the plurality of objects is to be recommended to at least one second object in the plurality of objects.

In some embodiments, the determination module 540 is further configured to: concatenate the first feature representation and the second feature representation to obtain a third feature representation; and determine, by using the prediction model, the first prediction result of the recommendation task based on the third feature representation.

In some embodiments, the decoding module 530 is further configured to: determine a missing feature representation corresponding to the input, the missing feature representation indicating a feature item, in the plurality of feature items, for which a corresponding feature is missing; and decode, by using the decoder model, the first feature representation based on the missing feature representation to obtain the second feature representation.

In some embodiments, the first prediction result includes an association degree between at least one first object in the plurality of objects and the at least one second object, and the first object is to be recommended to the at least one second object in accordance with the association degree exceeding a threshold association degree.

In some embodiments, the apparatus 500 may further include a training module, configured to train the encoder model and the decoder model by: determining a first sample input and a second sample input for a sample recommendation task, the first sample input including a plurality of sample features corresponding to a plurality of sample feature items of a sample object associated with the sample recommendation task, and the second sample input including a portion of sample features corresponding to the plurality of sample feature items; encoding the first sample input by using the encoder model to obtain a first sample feature representation, the first sample feature representation representing the plurality of sample features corresponding to the plurality of sample feature items; encoding the second sample input by using the encoder model to obtain a second sample feature representation, the second sample feature representation representing the portion of sample features corresponding to the plurality of sample feature items; decoding the second sample feature representation by using the decoder model to obtain a third sample feature representation, the third sample feature representation representing the plurality of sample features corresponding to the plurality of sample feature items; and adjusting a parameter of the encoder model and a parameter of the decoder model based on at least a first difference between the first sample feature representation and the third sample feature representation to obtain the trained encoder model and the trained decoder model.

In some embodiments, the training module is further configured to: remove sample feature(s) corresponding to one or more sample feature items from the first sample input to obtain the second sample input.

In some embodiments, the training module is further configured to: determine a time step parameter corresponding to the first sample input; determine a number of sample feature items to be removed from the first sample input based on the time step parameter; and remove sample feature(s) corresponding to the number of sample feature items from the first sample input to obtain the second sample input.

In some embodiments, the training module is further configured to: obtain a sample task result corresponding to the first sample input in the sample recommendation task; determine a second prediction result of the sample recommendation task by using the prediction model based on at least the third sample feature representation; and adjust the parameter of the encoder model and the parameter of the decoder model based on the first difference and a second difference between the sample task result and the second prediction result.

In some embodiments, the training module is further configured to: determine a third prediction result of the sample recommendation task by using the prediction model based on the second sample feature representation; and adjust the parameter of the encoder model and the parameter of the decoder model based on the first difference and a third difference between the sample recommendation task result and the third prediction result.

In some embodiments, the prediction model is jointly trained with the encoder model and the decoder model.

In some embodiments, the decoder model performs decoding based on a reverse diffusion process corresponding to a diffusion model.

The units and/or modules included in the apparatus 500 may be implemented in various manners, including software, hardware, firmware, or any combination thereof. In some embodiments, one or more units and/or modules may be implemented using software and/or firmware, for example machine-executable instructions stored on a storage medium. In addition to machine-executable instructions or as an alternative, some or all units and/or modules in the apparatus 500 may be implemented at least partially by one or more hardware logic components. As an example, rather than a limitation, example types of hardware logic components that may be used include field programmable gate array (FPGA), application specific integrated circuit (ASIC), application specific standard (ASSP), system on chip (SOC), complex programmable logic device (CPLD), and so on.

FIG. 6 is a block diagram of an electronic device 600 in which one or more embodiments of the present disclosure may be implemented. It should be understood that the electronic device 600 shown in FIG. 6 is merely exemplary, and should not constitute any limitation on the functionality and scope of the embodiments described herein. The electronic device 600 shown in FIG. 6 may include or be implemented as the server device 130 in FIG. 1 and the apparatus 500 in FIG. 5.

As shown in FIG. 6, the electronic device 600 is in the form of a general-purpose electronic device. Components of the electronic device 600 may include, but are not limited to, one or more processors 610, a memory 620, a storage device 630, one or more communication units 640, one or more input devices 650, and one or more output devices 660. The processor 610 may be an actual or virtual processor, and may perform various processing based on executable instructions stored in the memory 620. In a multi-processor system, a plurality of processors execute computer-executable instructions in parallel, to improve the parallel processing capability of the electronic device 600.

The electronic device 600 usually includes a plurality of computer storage medium. Such medium may be any available medium accessible by the electronic device 600, including, but not limited to, volatile and non-volatile medium, and removable and non-removable medium. The memory 620 may be a volatile memory (for example, a register, cache, or a random access memory (RAM)), a non-volatile memory (such as a read-only memory (ROM), an electrically erasable programmable read-only memory (EEPROM), or a flash memory), or any combination thereof. The storage device 630 may be any removable or non-removable medium, and may include a machine-readable medium, such as a flash drive, a disk, or any other medium, which may be used to store information and/or data and may be accessed in the electronic device 600.

The electronic device 600 may further include other removable/non-removable, volatile/non-volatile storage medium. Although not shown in FIG. 6, a disk driver for reading from or writing into removable and non-volatile disks (such as a “floppy disk”), and an optical disk driver for reading from or writing into removable and non-volatile optical disks may be provided. In these cases, each driver may be connected to a bus (not shown) through one or more data medium interfaces. The memory 620 may include a computer program product 625, which has one or more executable instruction modules configured to perform various methods or actions in the embodiments of the present disclosure.

The communication unit 640 implements communication with another electronic device through a communication medium. In addition, the functions of the components of the electronic device 600 may be implemented by a single computing cluster or a plurality of computing machines, which may communicate through a communication connection. Therefore, the electronic device 600 may use a logical connection with one or more other servers, a network personal computer (PC), or another network node to operate in a networked environment.

The input device 650 may be one or more input devices, such as a mouse, a keyboard, or a tracking ball. The output device 660 may be one or more output devices, such as a display, a speaker, or a printer. The electronic device 600 may further communicate with one or more external devices (not shown) through the communication unit 640 as needed, the external devices such as a storage device or a display device, communicate with one or more devices that enable a user to interact with the electronic device 600, or communicate with any devices (for example, a network card or a modem) that enable the electronic device 600 to communicate with one or more other electronic devices. Such communication may be performed through input/output (I/O) interfaces (not shown).

According to an example implementation of the present disclosure, there is provided a computer-readable storage medium having computer-executable instructions stored thereon, where the computer-executable instructions are executed by a processor to implement the method described above. According to an example implementation of the present disclosure, there is further provided a computer-executable instruction product. The computer-executable instruction product is tangibly stored on a non-transitory computer-readable medium, and includes computer-executable instructions. The computer-executable instructions are executed by a processor to implement the method described above.

Various aspects of the present disclosure are described herein with reference to flowcharts and/or block diagrams of methods, apparatuses, devices, and computer-executable instruction products implemented according to the present disclosure. It should be understood that each block of the flowchart and/or block diagram, and each combination of blocks in the flowchart and/or block diagram may be implemented by computer-readable executable instructions.

These computer-executable instructions may be provided to a processor of a general-purpose computer, a dedicated computer, or another programmable data processing apparatus, to produce a machine, so that when the instructions are executed by the processor of the computer or the another programmable data processing apparatus, an apparatus for implementing a specific function/action in one or more blocks in the flowchart and/or block diagram is generated. These computer-executable instructions may alternatively be stored in a computer-readable storage medium, and the instructions cause the computer, the programmable data processing apparatus, and/or another device to work in a specific manner. Therefore, the computer-readable medium in which the instructions are stored includes a manufactured product, which includes instructions for implementing various aspects of a specific function/action in one or more blocks in the flowchart and/or block diagram.

The computer-executable instructions may be loaded onto a computer, another programmable data processing apparatus, or another device, to perform a series of operation steps on the computer, another programmable data processing apparatus, or another device, to generate a computer-implemented process. Therefore, the instructions executed on the computer, another programmable data processing apparatus, or another device implement a specific function/action in one or more blocks in the flowchart and/or block diagram.

The flowchart and block diagram in the drawings show the possibly implemented architectures, functions, and operations of the system, the method, and the computer-executable instruction product according to a plurality of implementations of the present disclosure. In this regard, each block in the flowchart or block diagram may represent a module, executable instructions, or apart of instructions, and the module, the executable instructions, or the part of instructions includes one or more executable instructions for implementing a specific logical function. In some alternative implementations, the functions marked in the blocks may alternatively occur in an order different from that marked in the drawings. For example, two consecutive blocks may actually be performed substantially in parallel, or they may sometimes be performed in the reverse order, depending on the functions involved. It should also be noted that each block in the block diagram and/or the flowchart, and each combination of blocks in the block diagram and/or the flowchart may be implemented by a dedicated hardware-based system that executes specific functions or actions, or may be implemented by a combination of dedicated hardware and computer instructions.

The implementations of the present disclosure have been described above. The above description is exemplary, not exhaustive, and is not limited to the disclosed implementations. Without departing from the scope and spirit of the illustrated implementations, many modifications and variations will be apparent to those of ordinary skill in the art. The terms used herein are intended to best explain the principles, actual applications, or improvements to the technologies in the market of the implementations, or to enable other persons of ordinary skill in the art to understand the implementations disclosed herein.

1. A method for task result prediction, comprising:
obtaining an input to a recommendation task, the input comprising at least one feature corresponding to a plurality of feature items of a plurality of objects associated with the recommendation task;
encoding the input by using a trained encoder model to obtain a first feature representation, the first feature representation representing the at least one feature corresponding to the plurality of feature items;
decoding the first feature representation by using a trained decoder model to obtain a second feature representation, the second feature representation representing a plurality of features corresponding to the plurality of feature items; and
determining, by using a trained prediction model, a first prediction result of the recommendation task based on at least the second feature representation, the first prediction result indicating whether a first object of the plurality of objects is to be recommended to at least one second object of the plurality of objects.

2. The method of claim 1, wherein determining the first prediction result of the recommendation task comprises:
concatenating the first feature representation and the second feature representation to obtain a third feature representation; and
determining, by using the prediction model, the first prediction result of the recommendation task based on the third feature representation.

3. The method of claim 1, wherein decoding the first feature representation by using the trained decoder model to obtain the second feature representation comprises:
determining a missing feature representation corresponding to the input, the missing feature representation indicating a feature item in the plurality of feature items, a corresponding feature for the feature item in the plurality of feature items is missing; and
decoding, by using the decoder model, the first feature representation based on the missing feature representation to obtain the second feature representation.

4. The method of claim 1, wherein the first prediction result comprises an association degree between at least one first object of the plurality of objects and the at least one second object, and wherein the first object is to be recommended to the at least one second object in accordance with the association degree exceeding a threshold association degree.

5. The method of claim 1, wherein the encoder model and the decoder model are trained by:
determining a first sample input and a second sample input for a sample recommendation task, the first sample input comprising a plurality of sample features corresponding to a plurality of sample feature items of a sample object associated with the sample recommendation task, and the second sample input comprising a portion of sample features corresponding to the plurality of sample feature items;
encoding the first sample input by using the encoder model to obtain a first sample feature representation, the first sample feature representation representing the plurality of sample features corresponding to the plurality of sample feature items;
encoding the second sample input by using the encoder model to obtain a second sample feature representation, the second sample feature representation representing the portion of sample features corresponding to the plurality of sample feature items;
decoding the second sample feature representation by using the decoder model to obtain a third sample feature representation, the third sample feature representation representing the plurality of sample features corresponding to the plurality of sample feature items; and
adjusting a parameter of the encoder model and a parameter of the decoder model based on at least a first difference between the first sample feature representation and the third sample feature representation to obtain the trained encoder model and the trained decoder model.

6. The method of claim 5, wherein the second sample input is determined by:
removing one or more sample features corresponding to one or more sample feature items from the first sample input to obtain the second sample input.

7. The method of claim 6, wherein removing the one or more sample features corresponding to the one or more sample feature items from the first sample input to obtain the second sample input comprises:
determining a time step parameter corresponding to the first sample input;
determining, based on the time step parameter, a number of sample feature items to be removed from the first sample input; and
removing at least one sample feature corresponding to the number of sample feature items from the first sample input to obtain the second sample input.

8. The method of claim 5, wherein adjusting the parameter of the encoder model and the parameter of the decoder model comprises:
obtaining a sample task result corresponding to the first sample input in the sample recommendation task;
determining a second prediction result of the sample recommendation task by using the prediction model based on at least the third sample feature representation; and
adjusting the parameter of the encoder model and the parameter of the decoder model based on the first difference and a second difference between the sample task result and the second prediction result.

9. The method of claim 5, wherein adjusting the parameter of the encoder model and the parameter of the decoder model comprises:
determining a third prediction result of the sample recommendation task by using the prediction model based on the second sample feature representation; and
adjusting the parameter of the encoder model and the parameter of the decoder model based on the first difference and a third difference between the sample task result and the third prediction result.

10. The method of claim 5, wherein the prediction model is jointly trained with the encoder model and the decoder model.

11. The method of claim 1, wherein the decoder model performs decoding based on a reverse diffusion process corresponding to a diffusion model.

12. An electronic device, comprising:
at least one processor; and
at least one memory coupled to the at least one processor and storing instructions for execution by the at least one processor, the instructions, when executed by the at least one processor, causing the electronic device to perform acts comprising:
obtaining an input to a recommendation task, the input comprising at least one feature corresponding to a plurality of feature items of a plurality of objects associated with the recommendation task;
encoding the input by using a trained encoder model to obtain a first feature representation, the first feature representation representing the at least one feature corresponding to the plurality of feature items;
decoding the first feature representation by using a trained decoder model to obtain a second feature representation, the second feature representation representing a plurality of features corresponding to the plurality of feature items; and
determining, by using a trained prediction model, a first prediction result of the recommendation task based on at least the second feature representation, the first prediction result indicating whether a first object of the plurality of objects is to be recommended to at least one second object of the plurality of objects.

13. The electronic device of claim 12, wherein determining the first prediction result of the recommendation task comprises:
concatenating the first feature representation and the second feature representation to obtain a third feature representation; and
determining, by using the prediction model, the first prediction result of the recommendation task based on the third feature representation.

14. The electronic device of claim 12, wherein decoding the first feature representation by using the trained decoder model to obtain the second feature representation comprises:
determining a missing feature representation corresponding to the input, the missing feature representation indicating a feature item in the plurality of feature items, a corresponding feature for the feature item in the plurality of feature items is missing; and
decoding, by using the decoder model, the first feature representation based on the missing feature representation to obtain the second feature representation.

15. The electronic device of claim 12, wherein the first prediction result comprises an association degree between at least one first object of the plurality of objects and the at least one second object, and wherein the first object is to be recommended to the at least one second object in accordance with the association degree exceeding a threshold association degree.

16. The electronic device of claim 12, wherein the encoder model and the decoder model are trained by:
determining a first sample input and a second sample input for a sample recommendation task, the first sample input comprising a plurality of sample features corresponding to a plurality of sample feature items of a sample object associated with the sample recommendation task, and the second sample input comprising a portion of sample features corresponding to the plurality of sample feature items;
encoding the first sample input by using the encoder model to obtain a first sample feature representation, the first sample feature representation representing the plurality of sample features corresponding to the plurality of sample feature items;
encoding the second sample input by using the encoder model to obtain a second sample feature representation, the second sample feature representation representing the portion of sample features corresponding to the plurality of sample feature items;
decoding the second sample feature representation by using the decoder model to obtain a third sample feature representation, the third sample feature representation representing the plurality of sample features corresponding to the plurality of sample feature items; and
adjusting a parameter of the encoder model and a parameter of the decoder model based on at least a first difference between the first sample feature representation and the third sample feature representation to obtain the trained encoder model and the trained decoder model.

17. The electronic device of claim 16, wherein the second sample input is determined by:
removing one or more sample features corresponding to one or more sample feature items from the first sample input to obtain the second sample input.

18. The electronic device of claim 17, wherein removing the one or more sample features corresponding to the one or more sample feature items from the first sample input to obtain the second sample input comprises:
determining a time step parameter corresponding to the first sample input;
determining, based on the time step parameter, a number of sample feature items to be removed from the first sample input; and
removing at least one sample feature corresponding to the number of sample feature items from the first sample input to obtain the second sample input.

19. The electronic device of claim 16, wherein adjusting the parameter of the encoder model and the parameter of the decoder model comprises:
obtaining a sample task result corresponding to the first sample input in the sample recommendation task;
determining a second prediction result of the sample recommendation task by using the prediction model based on at least the third sample feature representation; and
adjusting the parameter of the encoder model and the parameter of the decoder model based on the first difference and a second difference between the sample task result and the second prediction result.

20. A non-transitory computer-readable storage medium having computer-executable instructions stored thereon, the computer-executable instructions being executable by a processor to implement acts comprising:
obtaining an input to a recommendation task, the input comprising at least one feature corresponding to a plurality of feature items of a plurality of objects associated with the recommendation task;
encoding the input by using a trained encoder model to obtain a first feature representation, the first feature representation representing the at least one feature corresponding to the plurality of feature items;
decoding the first feature representation by using a trained decoder model to obtain a second feature representation, the second feature representation representing a plurality of features corresponding to the plurality of feature items; and
determining, by using a trained prediction model, a first prediction result of the recommendation task based on at least the second feature representation, the first prediction result indicating whether a first object of the plurality of objects is to be recommended to at least one second object of the plurality of objects.
